(19) United States
(12) Patent Application Publication
(10) Pub. No.: US 2017/0240227 A1
(43) Pub. Date: Aug. 24, 2017

(54) SUPPORTING SYSTEM FOR A SPARE TIRE FOR A VEHICLE, SUCH AS TRUCK OR THE LIKE

(71) Applicant: TAKLER S.R.L., Altamura (IT)

(72) Inventor: LORENZO LORUSSO, Altamura (IT)

(73) Assignee: TAKLER S.R.L., Altamura (IT)

(21) Appl. No.: 15/511,853

(22) PCT Filed: Sep. 25, 2015
(86) PCT No.: PCT/IT2015/000240

§ 371 Date: Mar. 16, 2017

(30) Foreign Application Priority Data
Sep. 26, 2014 (IT) RO2014A000554

(51) Int. Cl. B62D 43/04; B62D 33/02

(52) U.S. Cl. CPC B62D 43/04; B62D 33/0207

(57) ABSTRACT

The present invention concerns a supporting system (S) for a spare tire (R) for a vehicle, such as a camion, a truck, a trailer, or a semi-trailer and the like, said vehicle being of the type provided at the bottom with a chassis, said system (S) comprising: a supporting structure (1) fixable to the chassis of said vehicle; a sliding structure (2), slidingly coupled with said supporting structure (1), so as to assume a retracted position, where said sliding structure (2) is wholly or partly arranged under said vehicle, and an extracted position, where said sliding structure (2) is wholly or partly extracted from said vehicle; and supporting means (3) rotatably coupled with said sliding structure (2) and suitable to receive said spare tire (R) of said vehicle, said supporting means (3) being capable to move from a rest position, to an operating position, where said spare tire (R) is substantially arranged orthogonally with respect to the ground.

The present invention relates to a system for supporting a spare wheel for a vehicle, such as a truck and the like.

More specifically, the invention concerns a system of the above kind, studied and realized in particular for housing a spare wheel on board of a vehicle, but which can be used for any means for which is required the housing function of a spare wheel on board.

In the following, the description will be directed to system for supporting a spare wheel, which is mounted on the chassis of trucks, trailers, semi-trailers, trucks and the like, but it is clear that the same should not be considered limited to this specific use.

As it is well known, currently spare wheels for a large vehicle are firmly housed in a recess formed in the lower part of the vehicle itself.

If necessary, the user, typically the driver of the vehicle, must reach the recess, manually remove the wheel and bring it to the damaged wheel.

In addition, the user should subsequently house the damaged wheel in the recess by lifting it from the ground and placing it in the recess.

It is known that the wheels of large vehicles have a weight of about 100 kg. Therefore, the user must make a great physical effort to extract the spare wheel from the recess and subsequently storing the damaged wheel.

In light of the above, it is, therefore, object of the present invention providing a system, which allows to easily extract the spare wheel from the vehicle and to easily load the damaged wheel on the vehicle.

Another object of the present invention is to provide an entirely mechanical system for supporting a spare wheel, which can be easily operated by a user.

It is therefore specific object of the present invention a supporting system for a spare tire for a vehicle, such as a camion, a truck, a trailer, or a semi-trailer and the like, said vehicle being of the type provided at the bottom with a chassis, said system comprising: a supporting structure fixable to the chassis of said vehicle; a sliding structure, slidingly coupled with said supporting structure, so as to assume a retracted position, where said sliding structure is wholly or partly arranged under said vehicle, and an extracted position, where said sliding structure is wholly or partly extracted from said vehicle; and supporting means rotatably coupled with said sliding structure and suitable to receive said spare tire of said vehicle, said supporting means being capable to move from a rest position, to an operating position, where said spare tire is substantially arranged orthogonally with respect to the ground.

Preferably according to the invention, said supporting structure comprises a first and a second sliding track and a first and a second blocking element, such that said first and a second blocking element are fixable to said chassis of said vehicle and are suitable to support said first and a second sliding track, in order to make them integral with said chassis of said vehicle.

Further according to the invention, said sliding structure comprises a plurality of coupling sliding means, comprising wheels, in order to couple said sliding structure and said supporting structure, such that said sliding structure can move from said retracted position to said extracted position and vice versa, along said first and second sliding track.

Still according to the invention, said sliding structure has a substantially polyhedral shape, in particular a parallelepiped, and it comprises a first and a second face rigidly coupled with each other by a plurality of bars.

Always according to the invention, said supporting means comprise a supporting board, suitable to receive said spare tire, means for coupling to said sliding structure and anchoring means, suitable to cushion the rotation of said supporting board when passing from said operating position to said rest position.

Preferably according to the invention, said supporting board comprises a first and second lateral projection, said first lateral projection being coupled with said first face of said sliding structure, and said second lateral projection being coupled with said second face of said sliding structure by said coupling means and by said anchoring means.

Further according to the invention, said anchoring means comprise a first and a second gas spring, such that said first gas spring is adapted to anchor said first lateral projection to said first face, and said second gas spring is adapted to anchor said second lateral projection to said second face.

Still according to the invention, said supporting board is shaped so as to receive said spire tire, and said supporting board has a plurality of holes suitable to lighten the weight of said supporting board.

Always according to the invention, said supporting means are provided with a security mechanism to block said supporting board in said operating position, to avoid the rollover of said supporting board.

Preferably according to the invention, said supporting means comprise a blocking device of said spare tire, suitable to fasten firmly said spare tire to said supporting board.

The present invention will be now described, for illustrative but not limitative purposes, according to its preferred embodiments, with particular reference to the figures of the enclosed drawings, wherein:

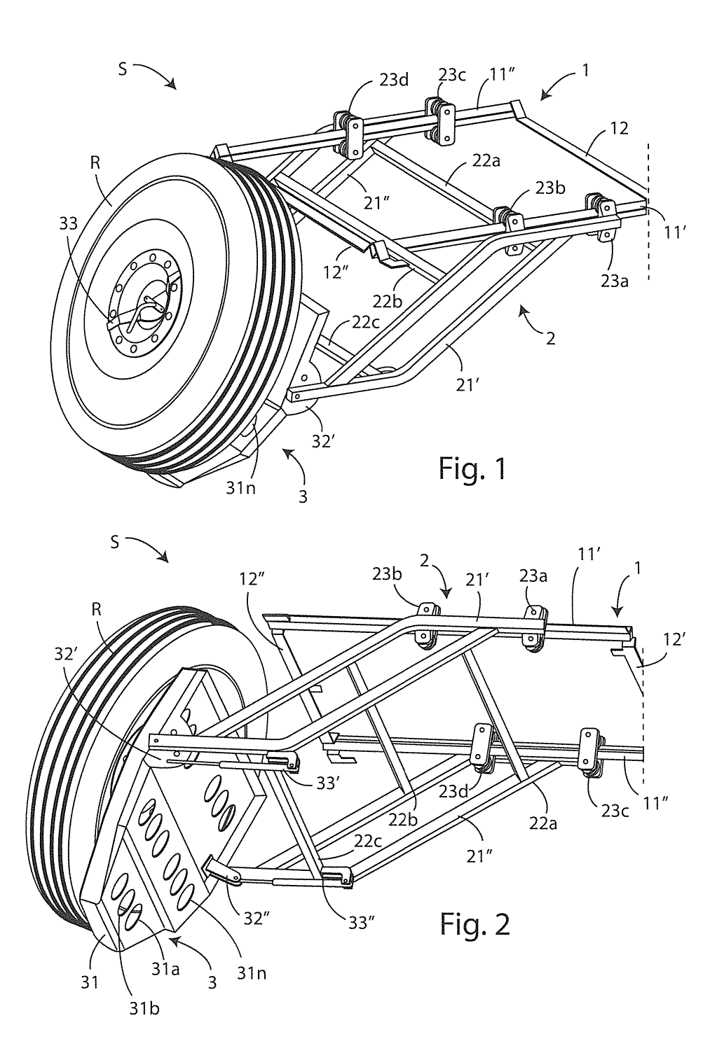

FIG. 1 shows a perspective view of the system for supporting a spare wheel for a vehicle, such as a truck and the like, object of the present invention;

FIG. 2 shows a perspective view from the bottom of the system of FIG. 1;

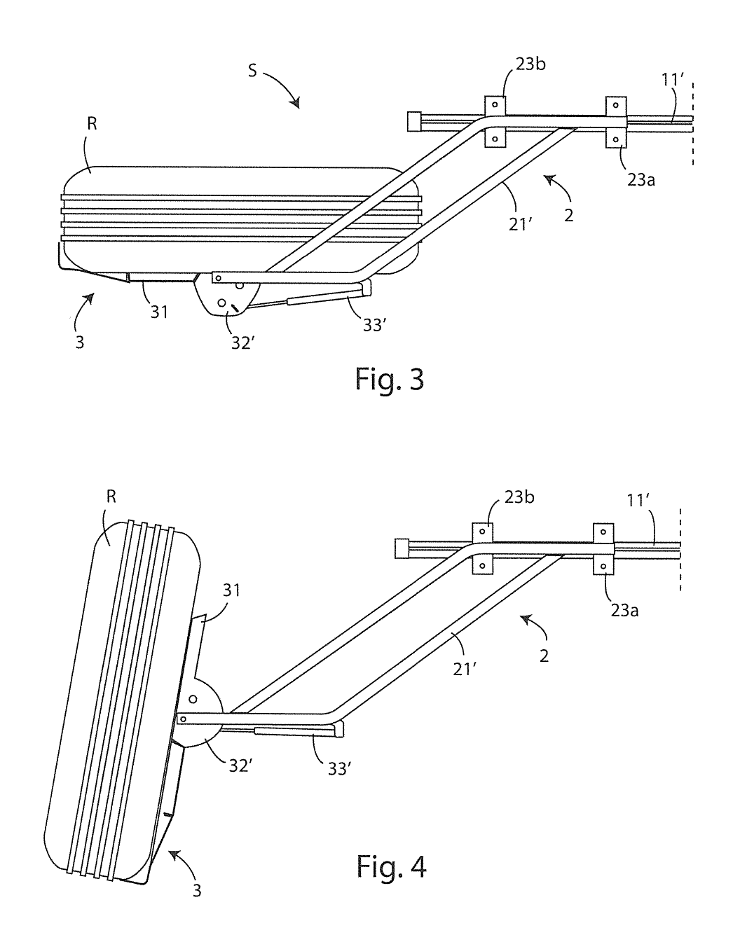

FIG. 3 shows a side view of the system of FIG. 1 in an operating configuration; and

FIG. 4 shows a side view of the system of FIG. 1 in a further operating configuration.

In the various figures, similar parts will be indicated by the same reference numbers.

Referring to FIG. 1, the system for supporting a spare wheel, object of the present invention, allows to house a spare wheel R on board of a truck and to remove it mechanically.

In particular, the spare wheel R support system S comprises a support structure 1, mounted integrally on the frame of the lower part of a truck, adapted to support other structures that compose the system S; a sliding frame 2, slidingly coupled to said support structure 1, for moving the spare wheel R, and supporting means 3, rotatably coupled with said sliding structure 2, on which the spare wheel R is housed.

In particular, the support structure 1 comprises a first 11′ and a second 11″ sliding track and a first 12′ and a second 12″ locking element.

Said first 12′ and second 12″ blocking element are firmly fixed to the chassis of a truck by means of wheels and anchoring clamps, not shown in the figure, and are suitable for supporting said first and second 11″ sliding track, so as to make it integral with the chassis of the truck.

As regards the sliding structure 2, it can slide on said support structure, in particular along said first 11′ and second 11″ sliding track.

The sliding structure 2, which has a shape similar to a polyhedron, in particular a parallelepiped, comprises a first 21′ and a second 21″ face firmly coupled together by a plurality of bars 22a, 22b, 22c.

Said sliding structure 2 is provided with a plurality of sliding coupling means 23a, 23b, 23c, 23d, comprising wheels, and integral with said first 21′ and second 21″ face, for coupling between said sliding structure 2 and said support structure 1, so that said sliding structure 2 can slide back and forth along said first 11′ and second 11″ sliding track, between a retracted position, in which said sliding structure 2 is completely arranged under the truck, and an extracted position, in which said sliding structure is completely extracted, so as to GO out of the truck.

As regards the support means 3, they comprise a supporting board 31, suitably shaped for housing a spare wheel R.

Said supporting board 31 further has a plurality of cavities 31a, 31b, . . . , 31N in order to lighten the weight of the supporting board 31 itself.

In addition, said supporting board 31 is rotatably coupled with said sliding structure 2.

In particular, said supporting board 31 comprises a first 32′ and a second 32″ lateral projection, in which said first lateral projection 32′ is coupled with said first face 21′ and said second lateral projection 32″ is coupled with said second face 21″ by means of rotating pins and by means of a first 33′ and a second 33″ gas spring, adapted to anchor said supporting board 31 to said sliding structure 2.

In particular, said first gas spring 33′ is adapted to anchor said first lateral projection 32′ to said first face 21′, while said second gas spring 33″ is adapted to anchor said second lateral projection 32″ to said second face 21″.

Referring to FIGS. 3 and 4, said support means 3 are capable of moving from a rest position, in which said supporting board 31, and then said spare wheel R, is parallel to the ground, and an operative position, in which said supporting board 31, and then said spare wheel R, is substantially perpendicular to the ground.

Said supporting means 3 are provided with a safety mechanism, not shown in the figure, which blocks said supporting board 31 in operative position, preventing the overturning, and a blocking device 33 of the wheel R, to firmly fix said spare wheel R to said supporting board 31.

The operation of the system for supporting a spare wheel described above is as follows.

Initially the system S is completely retracted under the truck, as said sliding structure 2 is in retracted position and said supporting means 3 are in the rest position.

When a user needs to replace a damaged wheel, extracts said sliding structure 2, by exerting a slight force on a part of said supporting board 31.

The wheels of said plurality of sliding coupling means 23a, 23b, 23c, 23d rotate on said first 11′ and second 11″ sliding track. Consequently, said sliding structure moves from said retracted position until reaches said extracted position.

Then, the user exerts a light pressure on said supporting board 31, which passes from said rest position to said operative position, in which said first 32′ and second 32″ gas spring extend and said safety mechanism is activated in order to block said supporting board 31 in said operative position.

The user can therefore act on the blocking device 33 of the wheel R to untying said spare wheel R from said supporting board 31.

Subsequently, the user pushes laterally said spare wheel R, in order to roll it on the ground and easily bring it where the damaged wheel has to be replaced.

Similarly, to load the damaged wheel, it is sufficient just repeating the steps according to a inverse procedure. In particular, it is sufficient loading the damaged wheel on said supporting board 31 by means of a lateral pushing, enabling the blocking device 33 of said wheel R, in order to ensure the damaged wheel on said supporting board 31, unlocking the safety mechanism, so that said supporting board 31 passes from said operative position to said rest position, exerting a light pushing on said supporting board 31, so that said sliding structure passes from said extracted position to said retracted position, sliding on said first 11′ and second 11″ sliding track.

As it is well evident from the preceding description, the spare wheel R can be easily extracted from the truck by simply sliding forward the sliding structure 3 and pushing down the supporting board 31, so that the spare wheel R can be on vertical position without the user having to exert a force to pull it out from the bottom of the truck and lift it from the ground.

The present invention has been described for illustrative but not limitative purposes, according to its preferred embodiments, but it is to be understood that modifications and/or changes can be introduced by those skilled in the art without departing from the relevant scope as defined in the enclosed claims.

1. Supporting system (S) for a spare tire (R) for a vehicle, such as a camion, a truck, a trailer, or a semi-trailer and the like, said vehicle being of the type provided at the bottom with a chassis, said system (S) comprising:
a supporting structure (1) fixable to the chassis of said vehicle;
a sliding structure (2), slidingly coupled with said supporting structure (1), so as to assume a retracted position, where said sliding structure (2) is wholly or partly arranged under said vehicle, and an extracted position, where said sliding structure (2) is wholly or partly extracted from said vehicle; and
supporting means (3) rotatably coupled with said sliding structure (2) and suitable to receive said spare tire (R) of said vehicle, said supporting means (3) being capable to move from a rest position, to an operating position, where said spare tire (R) is substantially arranged orthogonally with respect to the ground.

2. The supporting system (S) according to claim 1, characterized in that said supporting structure (1) comprises a first (11′) and a second (11″) sliding track and a first (12′) and a second (12″) blocking element, such that said first (12′) and a second (12″) blocking element are fixable to said chassis of said vehicle and are suitable to support said first (11′) and a second (11″) sliding track, in order to make them integral with said chassis of said vehicle.

3. The supporting system (S) according to claim 2, characterized in that said sliding structure (2) comprises a plurality of coupling sliding means (23a, 23b, 23c, 23d), comprising wheels, in order to couple said sliding structure (2) and said supporting structure (1), such that said sliding structure (2) can move from said retracted position to said extracted position and vice versa, along said first (11′) and second (11″) sliding track.

4. The supporting system (S) according to claim 1, characterized in that said sliding structure (2) has a substantially polyhedral shape, in particular a parallelepiped, and it comprises a first (21′) and a second (21″) face rigidly coupled with each other by a plurality of bars (22a, 22b, 22c).

5. The supporting system (S) according to claim 1, characterized in that said supporting means (3) comprise a supporting board (31), suitable to receive said spare tire (R), means for coupling to said sliding structure (2) and anchoring means (33′, 33″), suitable to cushion the rotation of said supporting board (31) when passing from said operating position to said rest position.

6. The supporting system (S) according to claim 5, characterized in that said supporting board (31) comprises a first (32′) and second (32″) lateral projection, said first lateral projection (32′) being coupled with said first face (21′) of said sliding structure (2), and said second lateral projection (32″) being coupled with said second face (21″) of said sliding structure (2) by said coupling means and by said anchoring means (33′, 33″).

7. The supporting system (S) according to claim 6, characterized in that said anchoring means (33′, 33″) comprise a first (33′) and a second (33″) gas spring, such that said first gas spring (33′) is adapted to anchor said first lateral projection (32′) to said first face (21′), and said second gas spring (33″) is adapted to anchor said second lateral projection (32″) to said second face (21″).

8. The supporting system (S) according to claim 5, characterized
in that said supporting board (31) is shaped so as to receive said spire tire (R), and
in that said supporting board (31) has a plurality of holes (31a, 31b, . . . , 31n) suitable to lighten the weight of said supporting board (31).

9. The supporting system (S) according to claim 5, characterized in that said supporting means (3) are provided with a security mechanism to block said supporting board (31) in said operating position, to avoid the rollover of said supporting board (31).

10. The supporting system (S) according to claim 5, characterized in that said supporting means (3) comprise a blocking device (33) of said spare tire (R), suitable to fasten firmly said spare tire (R) to said supporting board (31).
